(19) United States
(12) Patent Application Publication
(10) Pub. No.: US 2014/0232819 A1
(43) Pub. Date: Aug. 21, 2014

(54) SYSTEMS AND METHODS FOR GENERATING AND SHARING PANORAMIC MOMENTS

(71) Applicant: TOURWRIST, INC., San Francisco, CA (US)

(72) Inventor: Charles Robert Armstrong, San Francisco, CA (US)

(73) Assignee: TourWrist, Inc., San Francisco, CA (US)

(21) Appl. No.: 13/770,951

(22) Filed: Feb. 19, 2013

(51) Int. Cl. H04N 5/232

(52) U.S. Cl. CPC H04N 5/23238
USPC 348/39

(57) ABSTRACT

An entertainment server provides an entertainment consumer with visual entertainment media. The entertainment consumer sends a request to a panoramic moment generator to export a panoramic moment of the visual entertainment media to a viewer's display device for a viewer, the panoramic moment including panoramic content. The panoramic content can be comprised of still image(s) and/or video(s).

### BACKGROUND

The present invention relates to systems and methods for generating and sharing panoramic moments. More particularly, the present invention relates to the selective exportation of panoramic moment(s), generated from visual entertainment media, with one or more viewers.

The increasing convergence of online social media tools and three-dimensionally (3D) rendered entertainment media, such as video games, movies, and television shows, has been accompanied by the increasing expectation of users to be able to share each other's entertainment experiences.

For example, video games, movies, television shows and other forms of entertainment are increasingly created with artificial sets and characters. In most cases, these predominantly computer generated locations and cast members are designed—and in many cases, presented—using 3-dimensional (3D) rendering tools so that any angle can be viewed as dictated by either the publishing party or potentially the viewing party. At the same time, a growing demand for social sharing tools has increasingly become evident within the media industry. In much the same way that we now share our real-world experiences through photo and video, consumers are increasingly drawn toward the appeal of sharing virtual experiences as well.

It is therefore apparent that an urgent valued need exists for the ability for viewing visual entertainment media to share still or video moments in the form of panoramic exports that empower others to subsequently view such moments at the angles of their choosing.

### SUMMARY

To achieve the foregoing and in accordance with the present invention, systems and methods for sharing panoramic moments is provided. In particular, these systems and methods enable entertainment consumers to selectively share panoramic moment(s) of visual entertainment media with one or more viewers.

In one embodiment, an entertainment consumer receives, via a display device, a visual entertainment media from an entertainment server. The entertainment consumer sends a request, via the consumer's display device, to a panoramic moment generator to export a panoramic moment of the visual entertainment media to a second display device for a viewer, the panoramic moment including panoramic content selected by the entertainment consumer. The panoramic content includes one or more still images and/or one or more videos having a temporal proximity and a duration.

In some embodiments, the panoramic moment includes supplemental information and/or messages. The viewer's display device may send the viewer's viewing track of the panoramic moment back to the entertainment consumer. The entertainment server may provide the viewer and/or the entertainment consumer with recommendation(s) of potential panoramic moment(s).

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIGS. 1A, 1B and 1C are exemplary block diagrams illustrating entertainment systems for generating and exporting panoramic moments in accordance with three embodiments of the present invention;

FIG. 2 is a flow diagram illustrating the generation and exportation of panoramic moments in the embodiments of FIGS. 1A-1C; and

FIGS. 3, 4 and 5 are screenshots illustrating exemplary implementations for the embodiments of FIGS. 1A-1C.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

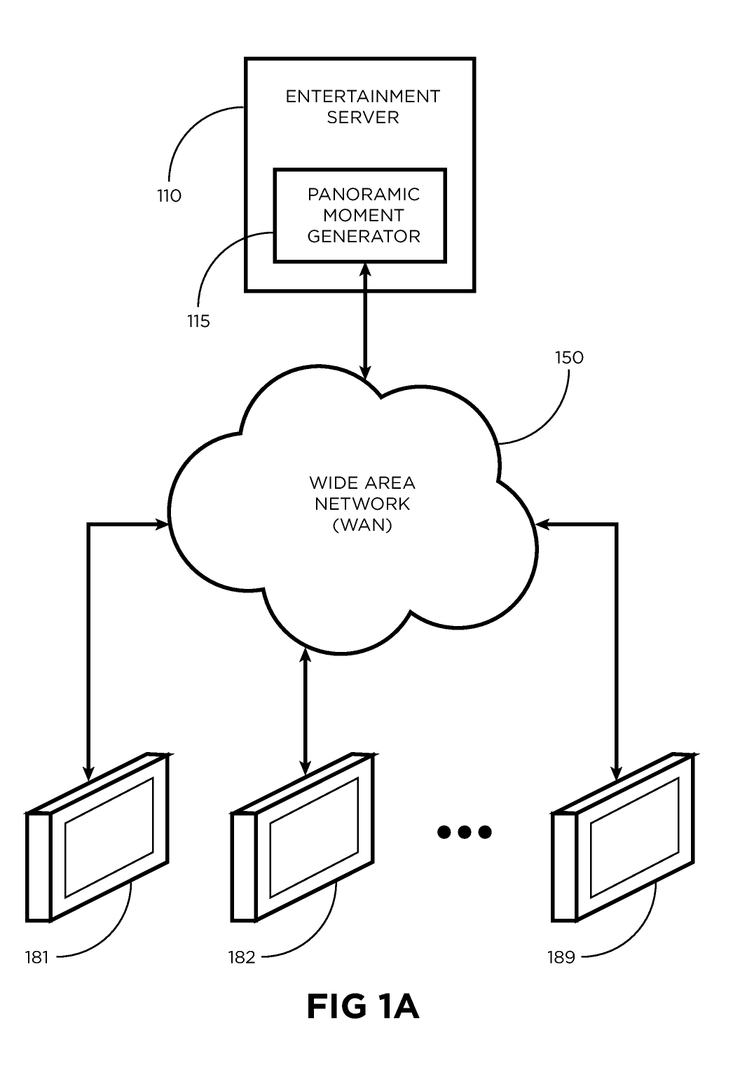

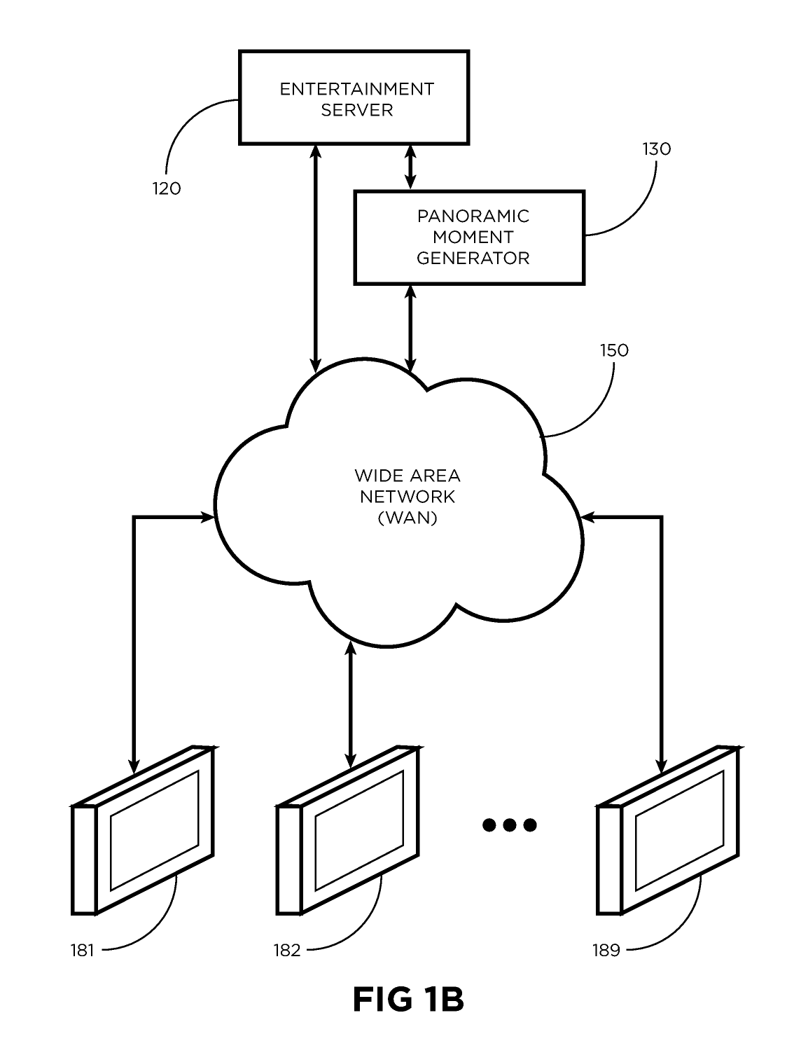

The present invention relates to systems and methods for enabling an entertainment consumer to selectively share panoramic moments of visual entertainment media with one or more viewers. To facilitate discussion, FIGS. 1A, 1B, and 1C are block diagrams showing three exemplary embodiments of entertainment systems capable of generating panoramic moments, as illustrated by the exemplary flow diagram of FIG. 2, in accordance with the present invention. Note that display devices 181, 182 . . . 189 can be any one of, for example, personal computers, laptops, tablets, smart phones, video game systems, their peripherals, and television monitors.

In one embodiment, as shown in FIG. 1A, an entertainment server 110 includes a panoramic moment generator 115 capable of creating and exporting panoramic moments, such as still panoramic images or animated sequences in the form of spherical, panoramic images or video. These panoramic moments can be exported by and shared between users operating display devices 181, 182 . . . 189 that are coupled to the panoramic moment generator 115 via a wide area network (WAN) 150, such as the internet. FIG. 1B illustrates an alternate embodiment wherein an entertainment server 120 and a separate panoramic moment generator 130 may be coupled to each other and are also coupled to display devices 181, 182, 189 via WAN 150. It is also possible for some or most of the functionality of the entertainment server and/or panoramic moment generator to be implemented in close proximity of and/or incorporated into the functionality of one or more of display devices 118, and 181, 182 . . . 189, such as in a video gaming system, as shown in yet another embodiment illustrated by FIG. 1C.

Panoramic moments can be represented in a variety of formats, including “equirectangular” projections of images or video. Such a format allows entire environments (with or without characters) to be recorded at all angles at once, and to be stored, per frame, as single images. Alternatively, panoramic moments can be stored as these omni-directional understandings of virtual environments and characters in the form of cube face textures (traditionally sets of 6 images). Regardless, once a panoramic moment has been recorded and/or exported, it is possible to then subsequently present the saved media in such a manner as to reproduce, or to produce for the first time, something that captures the immersive quality of content originally designed with a three-dimensional (3D) representational capability.

When combined with a suitable user interface to make this functionality available to those who are viewing, for example, three-dimensional (3D) generated media, a powerful, new function may be offered; the ability to share moments that can be re-experienced by the viewing party or others at a later time. This capability empowers the same viewing party to, subsequently, navigate further into pre-directed media, experiencing other angles of the same scenarios.

Referring now to the exemplary flow diagram of FIG. 2, during an entertainment session, visual entertainment media, e.g., three-dimensional (3D) entertainment media, can be rendered for an entertainment consumer operating display device 181 using rendering program(s) known to one skilled in the art (step 210). Entertainment media can be displayed using a two-dimensional (2D) display device such as a smart phone or tablet, or displayed using on a 3D-capable device such as a 3D television monitor (step 220). In step 230, during the entertainment session, the entertainment consumer can elect to export a panoramic moment that includes still image(s) and/or videos) to at least one other user operating, for example, display device 189. Such panoramic moments can be saved by the panoramic generator 115 (step 240).

In some embodiments, the entertainment consumer is able to determine where and/or with whom the panoramic moment is shared, and elects to make such a choice (step sequence 250, 260, 270, 280). Conversely, in other embodiments, the entertainment consumer may not be able to determine where and with whom the panoramic moment is shared (step sequence 250, 280).

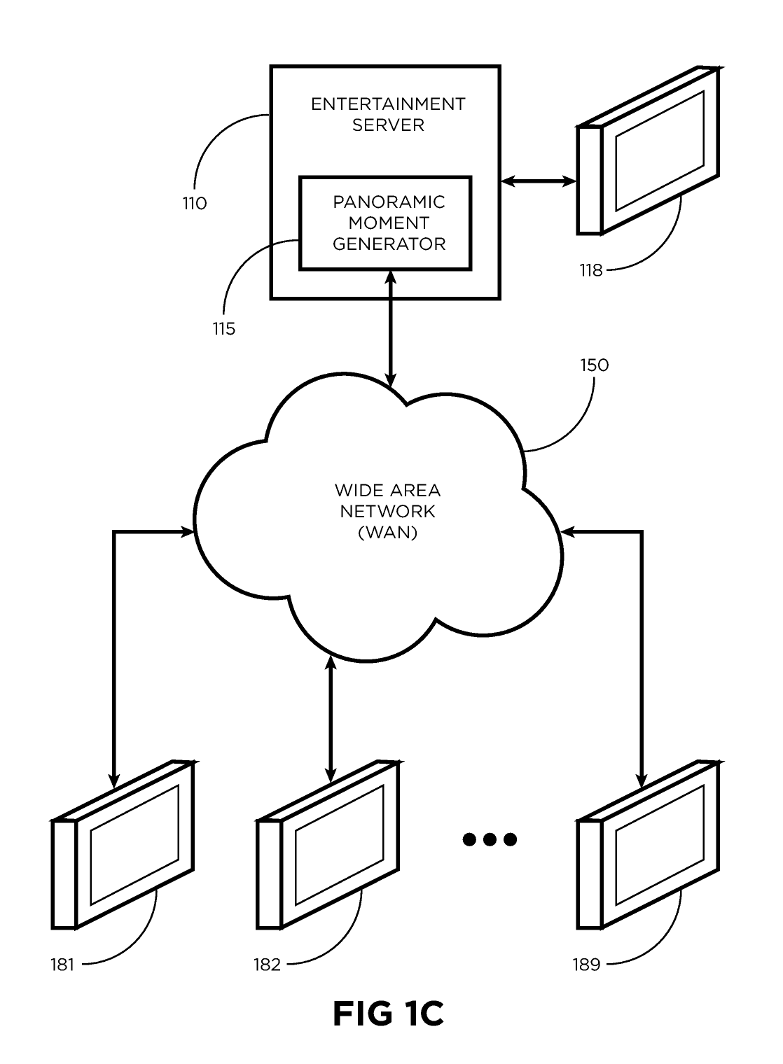

In one exemplary implementation as illustrated by the screenshot of FIG. 3, the use—case is that of a crime drama television show. As the show's investigators review a crime scene, the entertainment consumer has the option to download a more immersive, explorable version of the environment. By offering this capability, the entertainment consumer can be further immersed in the drama, essentially collaborating with the investigators as they unearth the mysteries of each scene.

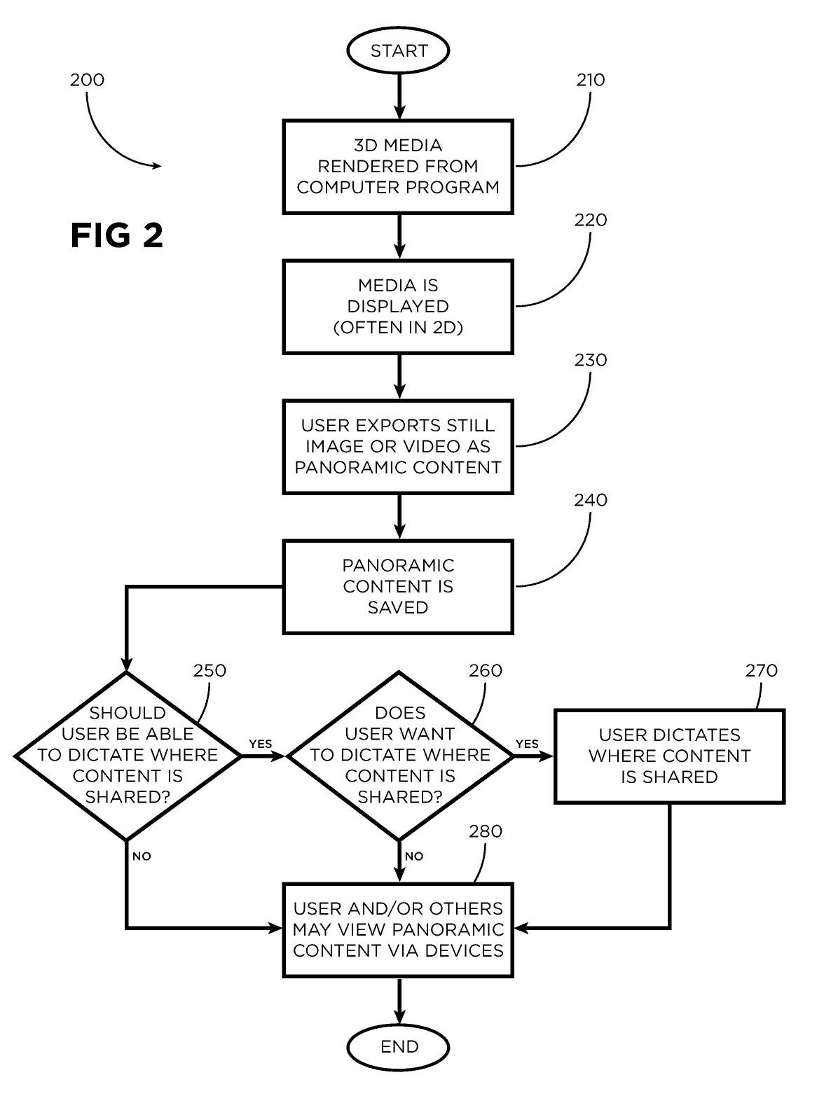

In another exemplary implementation as illustrated by screenshot of FIG. 4, an action video game includes a playable character surrounded by armed enemy combatants and artillery. As these foes are closing in on all sides, and as the playable character is fighting their way to freedom, the entertainment consumer may choose to click—or physically push—a button which causes the game to snap a 360-degree shot (panorama) of the moment, or a panoramic video of the past thirty seconds of the moment, and to then save it and/or share it with others.

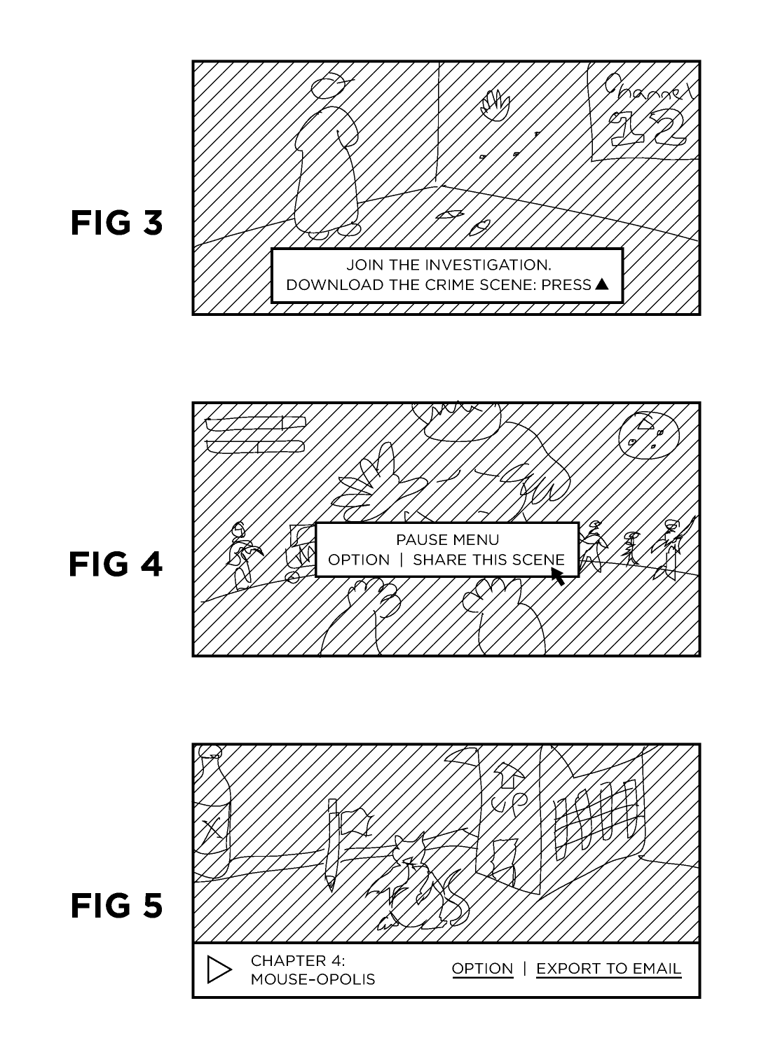

In yet another exemplary implementation as illustrated by the screenshot of FIG. 5, envision a family-friendly movie. In this example, an entertainment consumer is viewing a 3D animated movie about a family of mice who live under a house's floorboards. During the movie, the entertainment consumer may be shown a grand mouse-opolis, complete with household items repurposed to form a large fictional locale; perfect for other viewers, e.g., the entertainment consumer's friends, to re-explore after the movie. By offering the ability to save the view or clip as a panoramic moment, additional entertainment value can be extracted from the same 3D renderings.

Hence, as exemplified above, many possible implementations exist for the application of this novel combination of on-demand, 360-degree exports from visual entertainment media, and the means of viewing said exports as panoramic imagery on computer and mobile devices.

Depending on the device characteristics, display devices 181, 182 . . . 189 include appropriate hardware and/or software control mechanisms for generating and exporting the panoramic moments, including physical buttons, touch screens, keyboards, joysticks, position sensors, accelerometers, gyroscopes, and magnetometers. For example, an entertainment consumer may use a touch screen to select the location and duration of a panoramic video moment to be generated, and also to select the recipients. Hence user control mechanisms can include detection of finger movements, movements of the display devices, movements of the entertainment consumer, or any combination thereof

In some embodiments, a footer or sub-title with supplemental information, for example, statistical data (e.g., best scores), environmental data (e.g., weather, date & time), tactical data, (e.g., current field position, health and ammunition statuses), personal data (e.g., user name), foreign language translation(s), and group and/or personalized messages may be exported together with the panoramic moments. It is also possible to include a supplemental audio track in addition to or in place of, for example, visual supplement information, foreign language translations and/or messages. Optional sales and/or marketing media, such as advertisements and/or endorsements, may also be exported with the panoramic moments.

Many modifications and additions are also possible. For example, it is possible for a receiving viewer's display device to record and send the recipient's viewing track of the panoramic moment back to the entertainment consumer. It is also possible for entertainment server(s) to provide the viewer(s) and/or the entertainment consumer(s) with recommendation(s) of potential panoramic moment(s).

In sum, the present invention provides systems and methods for generating and exporting panoramic moments. The advantages of such systems and methods include the ability to spontaneously and easily share the experiences of the entertainment consumer with one or more viewers.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for sharing a user-selectable panoramic moment, useful in association a plurality of display devices coupled to each other via a network, the method comprising:
receiving, from a first display device, a request from an entertainment consumer to export a panoramic moment of a visual entertainment media, wherein the panoramic moment includes panoramic content selected by the entertainment consumer; and
generating and providing the panoramic moment to a second display device for a viewer.

2. The method of claim 1 wherein the panoramic content comprises at least one still image.

3. The method of claim 1 wherein the panoramic content comprises at least one video having at least one of a temporal proximity and a duration.

4. The method of claim 1 wherein the panoramic moment includes at least one of supplemental information, a foreign language translation and a message.

5. The method of claim 1 wherein the first display device receives, from the second display device, a viewing track of the panoramic moment by the viewer.

6. The method of claim 1 further comprising providing at least one recommended panoramic moment to at least one of the viewer and the entertainment consumer.

7. A computerized method for sharing a user-selectable panoramic moment, useful in association with a panoramic moment generator coupled to a plurality of display devices via a network, the method comprising:
receiving a visual entertainment media from an entertainment server, the visual entertainment media to be displayed at a first display device associated with an entertainment consumer; and
sending a request from the first display device to a panoramic moment generator to export a panoramic moment of the visual entertainment media to a second display device for a viewer, wherein the panoramic moment includes panoramic content selected by the entertainment consumer.

8. The method of claim 7 wherein the panoramic content comprises at least one still image.

9. The method of claim 7 wherein the panoramic content comprises at least one video having at least one of a temporal proximity and a duration.

10. The method of claim 7 wherein the panoramic moment includes at least one of supplemental information, a foreign language translation and a message.

11. The method of claim 7 further comprising receiving, from the second display device, a viewing track of the panoramic moment by the viewer.

12. The method of claim 7 further comprising receiving at least one recommended panoramic moment to at least one of the viewer and the entertainment server.

13. A computerized method for sharing a user-selectable panoramic moment, useful in association with a panoramic moment generator coupled to a plurality of display devices via a network, the method comprising:
displaying a visual entertainment media at a first display device associated with an entertainment consumer; and
generating and exporting a panoramic moment of the visual entertainment media to a second display device for a viewer, wherein the panoramic moment includes panoramic content selected by the entertainment consumer.

14. The method of claim 13 wherein the panoramic content comprises at least one still image.

15. The method of claim 13 wherein the panoramic content comprises at least one video having at least one of a temporal proximity and a duration.

16. The method of claim 13 wherein the panoramic moment includes at least one of supplemental information, a foreign language translation and a message.

17. The method of claim 13 wherein the first display device receives, from the second display device, a viewing track of the panoramic moment by the viewer.

18. The method of claim 13 further comprising providing at least one recommended panoramic moment to at least one of the viewer and the entertainment consumer.

19. The method of claim 13 further comprising exporting at least one of sales and marketing media with the panoramic moment.
